(19) United States
(12) Patent Application Publication
(10) Pub. No.: US 2026/0360823 A1
(43) Pub. Date: Nov. 12, 2026

(54) ALL-SOLID-STATE RECHARGEABLE BATTERIES

(71) Applicant: SAMSUNG SDI CO., LTD., Yongin-si, Gyeonggi-do (KR)

(72) Inventors: Jaejun LEE, Yongin-si, Gyeonggi-do (KR); Eungyeong LEE, Yongin-si, Gyeonggi-do (KR); Jaemin KIM, Yongin-si, Gyeonggi-do (KR); Gunwook LEE, Yongin-si, Gyeonggi-do (KR); Sieun LEE, Yongin-si, Gyeonggi-do (KR)

(73) Assignee: SAMSUNG SDI CO., LTD., Yongin-si, Gyeonggi-do (KR)

(21) Appl. No.: 18/880,535

(22) PCT Filed: Apr. 11, 2024
(86) PCT No.: PCT/KR2024/004871

§ 371 Date: Dec. 31, 2024

(30) Foreign Application Priority Data
Nov. 14, 2023 (KR) 10-2023-0157631

(51) Int. Cl. H01M 10/0585; H01M 10/052; H01M 10/0562

(52) U.S. Cl. CPC H01M 10/0585; H01M 10/052; H01M 10/0562; H01M 2300/008; H01M 2300/0094

(57) ABSTRACT

Provided is an all-solid-state rechargeable battery including a negative electrode, a positive electrode, and a solid electrolyte layer disposed between the negative electrode and the positive electrode, wherein the solid electrolyte layer includes a first solid electrolyte layer disposed in contact with the negative electrode and including a first solid electrolyte and a carbon composite; and a second solid electrolyte layer disposed in contact with the positive electrode and including a second solid electrolyte; the first solid electrolyte and the second solid electrolyte are in the form of particles, and an average particle diameter (D50) of the first solid electrolyte is smaller than an average particle diameter (D50) of the second solid electrolyte.

### TECHNICAL FIELD

All-solid-state rechargeable batteries are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there are safety issues such as explosion or fire of the batteries in the event of collision, penetration, and the like. Accordingly, an all-solid-state rechargeable battery using a solid electrolyte instead of an electrolyte solution has been proposed. All-solid-state rechargeable batteries are batteries in which all materials are made of solid, and thus they are safe as there is no risk of electrolyte solution leaking and exploding, and have the advantage of being easy to manufacture thin batteries.

### DISCLOSURE

Provided is an all-solid-state rechargeable battery having improved lithium ionic conductivity and overall battery performance.

According to an embodiment, an all-solid-state rechargeable battery includes a negative electrode, a positive electrode, and a solid electrolyte layer disposed between the negative electrode and the positive electrode,
wherein the solid electrolyte layer includes
a first solid electrolyte layer disposed in contact with the negative electrode and including a first solid electrolyte and a carbon composite; and a second solid electrolyte layer disposed in contact with the positive electrode and including a second solid electrolyte;
the first solid electrolyte and the second solid electrolyte are in the form of particles, and an average particle diameter (D50) of the first solid electrolyte is smaller than an average particle diameter (D50) of the second solid electrolyte.

The all-solid-state rechargeable battery according to an embodiment can exhibit improved battery performance by including a solid electrolyte having high lithium ionic conductivity.

### DESCRIPTION OF THE DRAWINGS

FIG. 1 is a cross-sectional view schematically illustrating an all-solid-state rechargeable battery according to an embodiment.

FIG. 2 is a cross-sectional view schematically illustrating an all-solid-state rechargeable battery according to another embodiment.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, a laminate, a composite, a copolymer, an alloy, a blend, a reaction product, and the like of the constituents.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D50) of particles having a cumulative volume of 50 volume % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

### All-Solid-State Rechargeable Battery

An all-solid-state rechargeable battery according to an embodiment includes a negative electrode, a positive electrode, and a solid electrolyte layer disposed between the negative electrode and the positive electrode, wherein the solid electrolyte layer includes a first solid electrolyte layer disposed in contact with the negative electrode and including a first solid electrolyte and a carbon composite; and a second solid electrolyte layer disposed in contact with the positive electrode and including a second solid electrolyte; the first solid electrolyte and the second solid electrolyte are in the form of particles, and an average particle diameter (D50) of the first solid electrolyte is smaller than an average particle diameter (D50) of the second solid electrolyte.

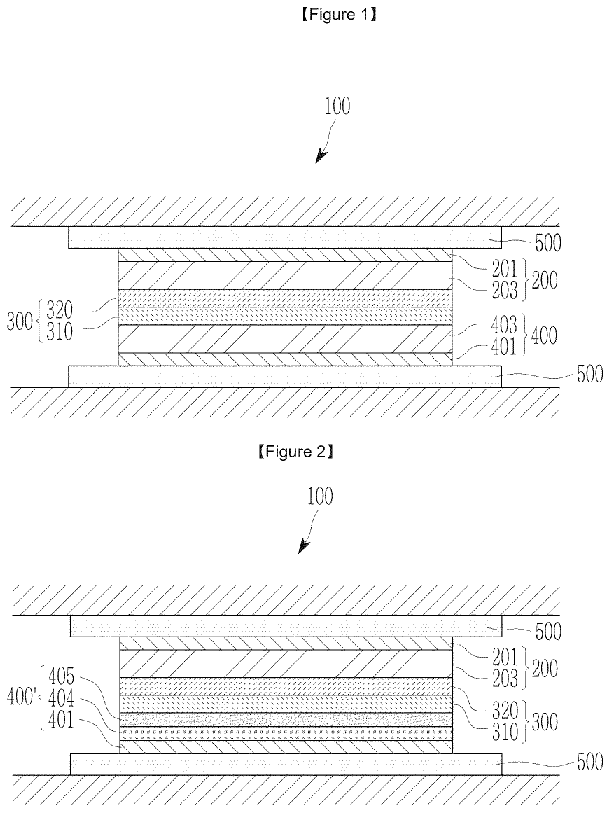

Hereinafter, an all-solid-state rechargeable battery according to an embodiment is described with reference to FIG. 1.

FIG. 1 is a cross-sectional view of an all-solid-state rechargeable battery according to an embodiment. Referring to FIG. 1, the all-solid-state rechargeable battery 100 may have a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case.

The all-solid-state rechargeable battery 100 may further include at least one elastic layer 500 on the outside of at least either one of the positive electrode 200 and the negative electrode 400.

Although FIG. 1 shows one electrode assembly including the negative electrode 400, the solid electrolyte layer 300, and the positive electrode 200, an all-solid-state rechargeable battery can also be manufactured by stacking two or more electrode assemblies.

For example, the all-solid-state rechargeable battery may be a unit cell having a structure of positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

### Solid Electrolyte Layer

In an all-solid-state rechargeable battery according to an embodiment, a solid electrolyte layer 300 includes a first solid electrolyte layer 310 arranged in contact with a negative electrode 400 and including a first solid electrolyte and a carbon composite, and a second solid electrolyte layer 320 arranged in contact with a positive electrode 200 and including a second solid electrolyte.

Here, the first solid electrolyte and the second solid electrolyte are each in the form of particles, and the average particle diameter (D50) of the first solid electrolyte is smaller than the average particle diameter (D50) of the second solid electrolyte.

By applying a first solid electrolyte having a relatively small average particle diameter to the first solid electrolyte layer 310 in contact with the negative electrode 400, pores can be reduced and a conductive path can be easily formed. In addition, by applying a second solid electrolyte having a relatively large average particle diameter to the second solid electrolyte layer 320 in contact with the positive electrode 200, the ionic conductivity at the interface with the positive electrode and the ionic conductivity inside the solid electrolyte layer can be increased.

An all-solid-state rechargeable battery according to an embodiment includes a double-layered solid electrolyte layer, and by controlling the particle size of the solid electrolyte included in each solid electrolyte layer, a generation of a section where contact between electrolyte particles does not occur can be minimized. Accordingly, the path through which lithium ions can move can be optimized to increase lithium ionic conductivity and improve the overall battery characteristics.

For example, the average particle size (D50) of the first solid electrolyte may be 0.1 μm to 2.0 μm, for example 0.1 μm to 1.5 μm, 0.1 μm to 1.0 μm, or 0.5 μm to 1.0 μm.

The average particle diameter (D50) of the second solid electrolyte may be 2.0 μm to 5.0 μm, for example 2.0 μm to 4.0 μm, or 2.5 μm to 3.0 μm.

The average particle diameter (D50) of the first and second solid electrolytes may be measured from an electron microscope image. For example, the particle size distribution may be obtained by measuring the size (diameter or length of the major axis) of about 20 particles in a scanning electron microscope image, and D50 may be calculated therefrom.

Meanwhile, the average particle diameter (D50) of each of the first solid electrolyte and the second solid electrolyte included in the solid electrolyte layer may be larger than the average particle diameter (D50) of the solid electrolyte included in the positive electrode 200. In this case, the energy density of the all-solid-state rechargeable battery can be maximized while increasing the mobility of lithium ions to improve the overall performance.

For example, the average particle size (D50) of the solid electrolyte included in the positive electrode 200 may be 0.1 μm to 1.9 μm, or 0.1 μm to 1.0 μm, or 0.1 μm to 0.5 μm. If these particle size ranges are satisfied, the energy density of the all-solid-state rechargeable battery may be maximized while the transfer of lithium ions is facilitated, thereby suppressing resistance and improving the overall performance of the all-solid-state rechargeable battery.

The first solid electrolyte layer 310 includes a carbon composite. The carbon composite is a material that can improve conductivity and increase lithium ionic conductivity. By including the carbon composite in the first solid electrolyte layer arranged in contact with the negative electrode, the phenomenon of the conductive path being disconnected after a charge/discharge cycle can be prevented, and the battery performance, such as implementing high capacity and high efficiency, may be improved.

The carbon composite includes a carbon-based material and metal particles, and may be in a composite form in which the metal particles are dispersed within the carbon-based material, between the carbon-based materials, on the surface of the carbon-based material, or in two or more of these locations. For example, a metal may be supported on the carbon-based material.

The carbon-based material may include amorphous carbon, crystalline carbon, or a mixture thereof. The amorphous carbon may include carbon black, vapor-grown carbon fibers (VGCF), acetylene black (AB), activated furnace black, or a combination thereof. The crystalline carbon may include natural graphite, artificial graphite, a carbon nanotube (CNT), graphene, or a combination thereof. The crystalline carbon may have an irregular, plate-like, flake-like, spherical, or fibrous shape.

The metal particles may include silicon, silver, zinc, tin, or a combination thereof.

Based on the total weight of the carbon-based material and the metal particles, a content of the metal particles may be 5 wt % to 40 wt %, and a content of the carbon-based material may be 60 to 95 wt %. In the above ranges, the metal can be evenly dispersed in the carbon-based material and well composited.

The carbon composite may be included in an amount of 1 wt % to 20 wt %, for example, 5 wt % to 20 wt %, or 5 wt % to 10 wt % based on the total weight of the first solid electrolyte layer. When the above range is satisfied, the lithium ionic conductivity can be significantly improved by minimizing the section where contact between solid electrolyte particles does not occur while improving the conductivity.

The types of the first solid electrolyte and the second solid electrolyte are not particularly limited, and may be the same or different.

Even when the types of the first solid electrolyte and the second solid electrolyte are the same, the average particle diameters (D50) may be different due to differences in monomers or compositions, and can be applied regardless as long as the average particle diameter of the first solid electrolyte is smaller than the average particle diameter of the second solid electrolyte.

The first solid electrolyte and the second solid electrolyte may each independently be an inorganic solid electrolyte such as a sulfide-based solid electrolyte or an oxide-based solid electrolyte, or a solid polymer electrolyte.

The solid electrolyte may be a sulfide-based solid electrolyte having excellent ionic conductivity, an oxide-based inorganic solid electrolyte, or a combination thereof.

The sulfide-based solid electrolyte may include, for example, Li₂S—P₂S₅, Li₂S—P₂S₅—LiX (wherein X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n is each an integer and Z is Ge, Zn, or Ga), Li₂S—GeS₂, Li₂S—SiS₂—Li₃PO₄, Li₂S—SiS₂-LiₚMO_{q} (wherein p and q each an integer and M is P, Si, Ge, B, Al, Ga, or In), and the like.

The sulfide-based solid electrolyte may be obtained, for example, by mixing Li₂S and P₂S₅ in a molar ratio of 50:50 to 90:10, or 50:50 to 80:20. Within the mixing ratio range, a sulfide-based solid electrolyte having excellent ionic conductivity may be prepared. Here, other components such as SiS₂, GeS₂, and B₂S₃ may be added to further improve the ionic conductivity.

Mechanical milling or solution method may be applied as a mixing method of sulfur-containing raw materials for preparing a sulfide-based solid electrolyte. The mechanical milling is to make starting materials into particulates by putting the starting materials and ball mills in a reactor and fervently stirring them. The solution method may be performed by mixing the starting materials in a solvent to obtain a solid electrolyte as a precipitate. Additionally, additional firing may be performed after mixing. If additional firing is performed, the solid electrolyte crystals can become more robust.

For example, the solid electrolyte may be an argyrodite-type sulfide-based solid electrolyte. The sulfide-based solid electrolyte may be, for example, LiₐM_{b}P_{c}S_{d}Aₑ (wherein a, b, c, d, and e are all 0 or more and 12 or less, M is Ge, Sₙ, Si, or a combination thereof, and A is one of F, Cl, Br, or I), and specifically, may be Li₃PS₄, Li₇P₃S₁₁, Li₆PS₅Cl, Li₆PS₅Br, Li₆PS₅I, etc. The sulfide-based solid electrolyte may have high ionic conductivity close to the range of 10⁻⁴ to 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state battery including this can have improved battery performances such as rate capability, coulombic efficiency, and cycle life characteristics.

The sulfide-based solid electrolyte may be amorphous or crystalline, or may be a mixture of the two.

The oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (LiPO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), L₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; and x is an integer of 1 to 10), or a mixture thereof.

Meanwhile, each of the first solid electrolyte layer and the second solid electrolyte layer may further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt may improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be an imide-based lithium salt, and for example, the imide-based lithium salt may include lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

The thickness of the first solid electrolyte layer 310 and the thickness of the second solid electrolyte layer 320 may be the same or different. For example, the thickness of the first solid electrolyte layer and the thickness of the second solid electrolyte layer may be substantially the same. The thickness of the first solid electrolyte layer may be 10 μm to 200 μm, for example 10 μm to 150 μm, 10 μm to 100 μm, or 20 μm to 80 μm. The thickness of the second solid electrolyte layer may be 10 μm to 200 μm, for example 10 μm to 150 μm, 10 μm to 100 μm, or 20 μm to 80 μm.

The solid electrolyte layer 300 may be in the form of a free-standing film. The free-standing film may mean one that can maintain its shape by itself without a separate support structure (e.g., a substrate such as a film or glass).

The free-standing film-type solid electrolyte layer may be manufactured by coating first and second solid electrolyte layers on a release film, stacking and pressing the first solid electrolyte layer and the second solid electrolyte layer so that they are in contact each other, and then removing the release film.

### Positive Electrode

In an embodiment, the device includes a positive electrode current collector 201 and a positive electrode active material layer 203 on the positive electrode current collector, wherein the positive electrode active material layer 203 includes a positive electrode active material and a solid electrolyte, and may optionally include a binder and/or a conductive material. In this case, the second solid electrolyte layer mentioned above may be a surface in contact with the positive electrode active material layer 203.

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas.

LiₐA_{1-b}X_{b}D₂ (0.90≤a≤1.8,0≤b≤0.5);

LiₐA_{1-b}X_{b}O_{2-c}D_{c} (0.90≤a≤1.8,0≤b≤0.5,0≤c≤0.05);

LiₐE_{1-b}X_{b}O_{2-c}D_{c} (0.90≤a≤1.8,0≤b≤0.5,0≤c≤0.05);

LiₐE_{2-b}X_{b}O_{4-c}D_{c} (0.90≤a≤1.8,0≤b≤0.5,0≤c≤0.05);

LiₐNi_{1-b-c}Co_{b}X_{c}D_{α} (0.90≤a≤1.8,0≤b≤0.5,0≤c≤0.5,0<α≤2);

LiₐNi_{1-b-c}Co_{b}X_{c}O_{2-α}T_{α} (0.90≤a≤1.8,0≤b≤0.5,0≤_{c}≤0.05,0<α<2);

LiₐNi_{1-b-c}Co_{b}X_{c}O_{2-α}T₂ (0.90≤a≤1.8,0≤b≤0.5,0≤c≤0.05,0<α<2);

LiₐNi_{1-b-c}Mn_{b}X_{c}D_{α} (0.90≤a≤1.8,0≤b≤0.5,0≤c≤0.05,0<α≤2);

LiₐNi_{1-b-c}Mn_{b}X_{c}O_{2-α}T_{α} (0.90≤a≤1.8,0≤b≤0.5,0≤c≤0.05,0<α<2);

LiₐNi_{1-b-c}Mn_{b}X_{c}O_{2-α}T₂ (0.90≤a≤1.8,0≤b≤0.5,0≤c≤0.05,0<α<2);

LiₐNi_{b}E_{c}G_{d}O₂ (0.90≤a≤1.8,0≤b≤0.9,0≤c≤0.5,0.001≤d≤0.1);

LiₐNi_{b}Co_{c}Mn_{d}GₑO₂ (0.90≤a≤1.8,0≤b≤0.9,0≤c≤0.5,0≤d≤0.5,0.001≤e≤0.1);

LiₐNiG_{b}O₂ (0.90≤a≤1.8,0.001≤b≤0.1);

LiₐCoG_{b}O₂ (0.90≤a≤1.8,0.001≤b≤0.1);

LiₐMn_{1-b}G_{b}O₂ (0.90≤a≤1.8,0.001≤b≤0.1);

LiₐMn₂G_{b}O₄ (0.90≤a≤1.8,0.001≤b≤0.1);

LiₐMn_{1-g}G_{g}PO₄ (0.90≤a≤1.8,0≤g≤0.5);

QO₂; QS₂; LiQS₂;

V₂O₅; LiV₂O₅;

LiZO₂;

LiNiVO₄;

Li_{(3-f)}J₂(PO₄)₃ (0≤f≤2);

Li_{(3-f)}Fe₂(PO₄)₃ (0≤f≤2); and

LiₐFePO₄ (0.90≤a≤1.8).

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), or lithium iron phosphate (LFP).

For example, the positive electrode active material may include lithium nickel-based oxide represented by Chemical Formula 1, lithium cobalt-based oxide represented by Chemical Formula 2, a lithium iron phosphate-based compound represented by Chemical Formula 3, and cobalt-free lithium nickel-manganese-based oxide represented by Chemical Formula 4, or a combination thereof.

Liₐ₁Niₓ₁M¹_{y1}M²_{z1}O_{2-b1}X_{b1} [Chemical Formula 1]

In Chemical Formula 1, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² are one or more elements independently selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 1, 0.6≤x1≤1, 0≤y1≤0.4, and 0≤z1≤0.4 or 0.8≤x1≤1, 0≤y1≤0.2, and 0≤z1≤0.2.

Liₐ₂Coₓ₂M³_{y2}O_{2-b2}X_{b2} [Chemical Formula 2]

In Chemical Formula 2, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sₙ, Sr, Ti, V, W, Y, Zn, and Zr, and X is one or more elements selected from F, P, and S.

Liₐ₃Feₓ₃M⁴_{y3}PO_{4-b3}X_{b3} [Chemical Formula 3]

In Chemical Formula 3, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sₙ, Sr, Ti, V, W, Y, Zn and Zr, and X is one or more elements selected from F, P, and S.

Liₐ₄Niₓ₄Mn_{y4}M⁵_{z4}O_{2-b4}X_{b4} [Chemical Formula 4]

In Chemical Formula 4, 0.9≤a2≤1.8, 0.8≤x4≤1, 0≤y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm.

For example, the positive electrode active material may include small particles having an average particle diameter (D50) of 1 μm to 9 μm and large particles having an average particle diameter (D50) of 10 μm to 25 μm. Here, a mixing ratio of the small particles and the large particles may be a weight ratio of about 10:90 to 40:60. The positive electrode active material having this particle size range can be harmoniously mixed with other components within the positive electrode active material layer and can achieve high capacity and high energy density.

Herein, the average particle diameter means a diameter (D50) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

The positive electrode active material may be included in an amount of 55 wt % to 99 wt %, for example, 65 wt % to 95 wt %, or 75 wt % to 91 wt % based on 100 wt % of the positive electrode active material layer.

The solid electrolyte included in the positive electrode active material layer may include a sulfide-based solid electrolyte, an oxide-based solid electrolyte, or a combination thereof, and may be, for example, an argyrodite-type sulfide-based solid electrolyte. Because the solid electrolyte has been described above, a detailed description thereof is omitted.

Based on 100 wt % of the positive electrode active material layer, the solid electrolyte may be included in an amount of 0.1 wt % to 35 wt %, for example, 1 wt % to 35 wt %, 5 wt % to 30 wt %, 8 wt % to 25 wt %, or 10 wt % to 20 wt %.

In addition, in the positive electrode active material layer, the positive electrode active material may be included in an amount of 65 wt % to 99 wt % and the solid electrolyte may be included in an amount of 1 wt % to 35 wt % based on the total weight of the positive electrode active material and the solid electrolyte, for example, the positive electrode active material may be included in an amount of 80 wt % to 90 wt % and the solid electrolyte may be included in an amount of 10 wt % to 20 wt %. When the solid electrolyte is included in the positive electrode in such a content, the efficiency and cycle-life characteristics of the all-solid-state battery may be improved without reducing the capacity.

The binder serves to adhere the positive electrode active material particles to each other and also to properly attach the positive electrode active material to the current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The content of the binder in the positive electrode active material layer may be approximately 0.1 wt % to 5 wt % based on 100 wt % of the positive electrode active material layer. Within the above content range, the binder can sufficiently exhibit adhesive ability without deteriorating battery performance.

The positive electrode active material layer may further include a conductive material. The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, a carbon nanotube, and the like; a metal-based material including copper, nickel, aluminum, silver, etc. in a form of a metal powder or a metal fiber; a conductive polymer such as a polyphenylene derivative:or a mixture thereof.

The content of the conductive material in the positive electrode active material layer may be 0 wt % to 3 wt %, 0.01 wt % to 2 wt %, or 0.1 wt % to 1 wt % based on 100 wt % of the positive electrode active material layer. In the above content range, the conductive material can improve electrical conductivity without degrading battery performance.

The positive electrode current collector may include an aluminum foil, but is not limited thereto.

### Negative Electrode

A negative electrode 400 for an all-solid-state rechargeable battery includes a negative electrode current collector 401 and a negative electrode active material layer 403 on the negative electrode current collector 401. The negative electrode active material layer includes a negative electrode active material and may further include a binder and/or a conductive material. In this case, the first solid electrolyte layer 310 described above may be a surface in contact with the negative electrode active material layer 403.

The positive electrode active material may be applied without limitation as long as it is generally used in all-solid-state rechargeable batteries. The negative electrode active material includes a material capable of reversibly intercalating/deintercalating lithium ions, a lithium metal, a lithium metal alloy, a material capable of doping/dedoping lithium, or transition metal oxide.

The material capable of reversibly intercalating/deintercalating lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Herein, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be used by mixing with a carbon-based negative electrode active material. When using a mixture of Si-based negative electrode active material or Sn-based negative electrode active material and carbon-based negative electrode active material, a mixing ratio thereof may be 1:99 to 90:10 by weight.

In the negative electrode active material layer, the negative electrode active material may be included in an amount of 95 wt % to 99 wt % based on the total weight of the negative electrode active material layer.

In an embodiment, the negative electrode active material layer further includes a binder and may optionally further include a conductive material. A content of the binder in the negative electrode active material layer may be 1 wt % to 5 wt % based on the total weight of the negative electrode active material layer. In addition, when further including a conductive material, the negative electrode active material layer may include 90 to 98 wt % of the negative electrode active material, 1 to 5 wt % of the binder, and 1 to 5 wt % of the conductive material.

The binder serves to attach the negative electrode active material particles well to each other and also to attach the negative electrode active material well to the current collector. The binder may include a water-insoluble, a water-soluble binder, or a combination thereof.

The water-insoluble binder may include, for example polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may include a rubber-based binder or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluorine rubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

In this case, the first solid electrolyte layer 310 may be a surface in contact with the negative electrode coating layer 405.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Herein, the precipitation of the lithium metal may be effectively promoted and improve characteristics of the all-solid-state battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm to 5 μm.

The precipitation-type negative electrode 400′ may further include a thin film, for example, on the surface of the current collector, that is, between the current collector and the negative electrode coating layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery.

The thin film may be formed, for example in a vacuum deposition method, a sputtering method, a plating method, and the like. The thin film may have, for example, a thickness of 1 nm to 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### MODE FOR INVENTION

Hereinafter, examples and comparative examples of the present invention will be described. The following examples are only examples of the present invention and the present invention is not limited to the following examples.

### EXAMPLES

### Example 1

### 1. Manufacturing of Negative Electrode

A negative electrode coating layer composition is prepared by mixing carbon black with a primary particle diameter (D50) of about 30 nm and silver (Ag) with an average particle diameter (D50) of about 60 nm in a weight ratio of 3:1 to prepare an Ag/C composite, adding 0.25 g of the Ag/C composite to 2 g of an NMP solution including 7 wt % of a polyvinylidene fluoride binder, and then, mixing them. The negative electrode coating layer composition is coated on a SUS current collector with a bar coater and then, vacuum-dried and compressed to manufacture a negative electrode including a negative electrode coating layer on the current collector.

### 2. Manufacturing of Positive Electrode

85 wt % of a positive electrode active material of LiNi_{0.9}Co_{0.05}Mn_{0.05}O₂coated with Li₂O—ZrO₂, 13.5 wt % of an argyrodite-type solid electrolyte of Li₆PS₅Cl, 1.0 wt % of a PVdF binder, and 0.5 wt % of a carbon nanotube conductive material are mixed in an OA solvent to prepare a positive electrode composition. A prepared positive electrode composition is coated on a positive electrode current collector using a bar coater and vacuum-dried to manufacture a positive electrode having a positive electrode active material layer formed on the current collector.

### 3. Manufacturing of Solid Electrolyte Layer

A first solid electrolyte (Li₆PS₅Cl, Mitsui Co., Ltd.) having an average particle size of about 1 μm, a carbon composite (Denka Black, Denka Co., Ltd.), and a dispersant are added to a binder solution in which an acrylic binder is dissolved in an octyl acetate (OA) solvent and stirred to prepare a first solid electrolyte layer slurry. The first solid electrolyte layer slurry includes 92 wt % of a first solid electrolyte, 6 wt % of a carbon composite, 1.3 wt % of a binder, and 0.7 wt % of a dispersant. The prepared first solid electrolyte layer slurry is cast on a polyethylene terephthalate (PET) release film with a thickness of about 50 μm and dried at room temperature to manufacture the first solid electrolyte layer.

A second solid electrolyte layer slurry is prepared by adding a second solid electrolyte (Li₆PS₅Cl, Mitsui Co., Ltd.) having an average particle size of approximately 3 μm and a dispersant to a binder solution in which an acrylic binder is dissolved in an octyl acetate (OA) solvent and stirring the solution. The second solid electrolyte layer slurry includes 98 wt % of a second solid electrolyte, 1.3 wt % of a binder, and 0.7 wt % of a dispersant. The prepared second solid electrolyte layer slurry is cast on a polyethylene terephthalate (PET) release film with a thickness of about 50 μm and dried at room temperature to manufacture the second solid electrolyte layer.

4. Manufacturing of all-Solid-State Rechargeable Battery Cell

A first solid electrolyte layer is stacked on the negative electrode so that the negative electrode active material layer is in contact with the first solid electrolyte layer in the manufactured negative electrode. A second solid electrolyte layer is stacked on the first solid electrolyte layer. A positive electrode is stacked on a second solid electrolyte layer so that the second solid electrolyte layer is in contact with the positive electrode active material layer.

The negative electrode, the first solid electrolyte layer, the second solid electrolyte layer, and the positive electrode are sequentially stacked to obtain an assembly, which is injected into a pouch, and then, the pouch is sealed and subjected to warm isostatic press (WIP) at a high temperature of 85 °C under 500 Mpa for 30 minutes to manufacture an all-solid-state rechargeable battery cell.

In the all-solid-state rechargeable battery cell, the first solid electrolyte layer and the second solid electrolyte layer respectively have a thickness of about 40 μm.

### Example 2

An all-solid-state rechargeable battery cell is manufactured in the same manner as in Example 1, except that the average particle size of the first solid electrolyte included in the first solid electrolyte layer is about 2 μm.

### Example 3

An all-solid-state rechargeable battery cell is manufactured in the same manner as in Example 1, except that the average particle size of the second solid electrolyte included in the second solid electrolyte layer is about 2 μm.

### Comparative Example 1

An all-solid-state rechargeable battery cell is manufactured in the same manner as in Example 1, except that the first solid electrolyte layer does not include a carbon composite and the first solid electrolyte layer slurry includes 98 wt % of the first solid electrolyte, 1.3 wt % of a binder, and 0.7 wt % of a dispersant.

### Comparative Example 2

An all-solid-state rechargeable battery cell is manufactured in the same manner as in Example 2, except that the first solid electrolyte layer does not include a carbon composite and the first solid electrolyte layer slurry includes 98 wt % of the first solid electrolyte, 1.3 wt % of a binder, and 0.7 wt % of a dispersant.

### Comparative Example 3

An all-solid-state rechargeable battery cell is manufactured in the same manner as in Example 3, except that the first solid electrolyte layer does not include a carbon composite and the first solid electrolyte layer slurry includes 98 wt % of the first solid electrolyte, 1.3 wt % of a binder, and 0.7 wt % of a dispersant.

TABLE 1

| | | | Second solid electrolyte |
|---|---|---|---|
| | First solid electrolyte layer | | layer |
| | First solid electrolyte | | Second solid electrolyte |
| | (average particle | Presence or absence | (average particle |
| | diameter) | of carbon composite | diameter) |
| Example 1 | Li₆PS₅Cl (1 μm) | Presence | Li₆PS₅Cl (3 μm) |
| Example 2 | Li₆PS₅Cl (2 μm) | Presence | Li₆PS₅Cl (3 μm) |
| Example 3 | Li₆PS₅Cl (1 μm) | Presence | Li₆PS₅Cl (2 μm) |
| Comparative | Li₆PS₅Cl (1 μm) | Absence | Li₆PS₅Cl (3 μm) |
| Example 1 | | | |
| Comparative | Li₆PS₅Cl (2 μm) | Absence | Li₆PS₅Cl (3 μm) |
| Example 2 | | | |
| Comparative | Li₆PS₅Cl (1 μm) | Absence | Li₆PS₅Cl (2 μm) |
| Example 3 | | | |

### Experimental Example: Initial Charge-Discharge Characteristics

For the all-solid-state rechargeable battery cells manufactured in Examples 1 to 3 and Comparative Examples 1 to 3, when charged at a constant current of 0.1 C at 45 °C to an upper limit voltage of 4.25 V, then charged at a constant voltage until a current of 0.05 C is reached, and discharged at 0.1 C to an end voltage of 2.5 V, the charge capacity and discharge capacity of each battery are shown in Table 2.

In addition, the ratios (%) of the discharge capacity to the charge b capacity are calculated as the charge/discharge efficiency and is shown in Table 2.

TABLE 2

| | Charge capacity | Discharge capacity | Charge/discharge |
|---|---|---|---|
| | (mAh/g) | (mAh/g) | efficiency (%) |
| Example 1 | 242.7 | 209.5 | 86.3 |
| Example 2 | 241.8 | 208.0 | 86.0 |
| Example 3 | 247.0 | 206.6 | 83.6 |
| Comparative | 242.5 | 206.8 | 85.2 |
| Example 1 | | | |
| Comparative | 242.0 | 207.7 | 85.8 |
| Example 2 | | | |
| Comparative | 244.2 | 190.8 | 78.1 |
| Example 3 | | | |

Referring to Table 2, the same level of initial charge/discharge performance is achieved in the all-solid-state rechargeable battery cells of Examples and Comparative Examples.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery
200: positive electrode
201: positive electrode current collector
203: positive electrode active material layer
300: solid electrolyte layer
310: first solid electrolyte layer
320: second solid electrolyte layer
400: negative electrode
401: negative electrode current collector
403: negative electrode active material layer
400′: precipitation-type negative electrode
404: lithium metal layer
405: negative electrode coating layer
500: elastic layer

1. An all-solid-state rechargeable battery
a negative electrode, a positive electrode, and a solid electrolyte layer disposed between the negative electrode and the positive electrode,
wherein the solid electrolyte layer comprises
a first solid electrolyte layer disposed in contact with the negative electrode and including a first solid electrolyte and a carbon composite; and a second solid electrolyte layer disposed in contact with the positive electrode and including a second solid electrolyte;
the first solid electrolyte and the second solid electrolyte are in the form of particles, and an average particle diameter (D50) of the first solid electrolyte is smaller than an average particle diameter (D50) of the second solid electrolyte.

2. The all-solid-state rechargeable battery as claimed in claim 1, wherein
an average particle diameter (D50) of the first solid electrolyte is 0.1 μm to 2.0 μm.

3. The all-solid-state rechargeable battery as claimed in claim 1, wherein
an average particle diameter (D50) of the second solid electrolyte is 2.0 μm to 5.0 μm.

4. The all-solid-state rechargeable battery as claimed in claim 1, wherein
the positive electrode comprises a solid electrolyte and an average particle diameter (D50) of the solid electrolyte is 0.1 μm to 0.5 μm.

5. The all-solid-state rechargeable battery as claimed in claim 1, wherein
the carbon composite comprises a carbon-based material and metal particles.

6. The all-solid-state rechargeable battery as claimed in claim 5, wherein
the carbon-based material comprises amorphous carbon, crystalline carbon, or a mixture thereof.

7. The all-solid-state rechargeable battery as claimed in claim 5, wherein
the metal particles comprise silicon, silver, zinc, tin, or a combination thereof.

8. The all-solid-state rechargeable battery as claimed in claim 5, wherein
based on the total weight of the carbon-based material and the metal particles,
a content of the metal particles is 5 wt % to 40 wt %, and a content of the b carbon-based material is 60 to 95 wt %.

9. The all-solid-state rechargeable battery as claimed in claim 1, wherein
the carbon composite is included in an amount of 1 wt % to 20 wt % based on the total weight of the first solid electrolyte layer.

10. The all-solid-state rechargeable battery as claimed in claim 1, wherein
a thickness of the first solid electrolyte layer is 10 μm to 200 μm, and
a thickness of the second solid electrolyte layer is 10 μm to 200 μm.

11. The all-solid-state rechargeable battery as claimed in claim 1, wherein
the first solid electrolyte and the second solid electrolyte are a sulfide-based solid electrolyte.

12. The all-solid-state rechargeable battery as claimed in claim 11, wherein
the sulfide-based solid electrolyte comprises an argyrodite-type sulfide.

13. The all-solid-state rechargeable battery as claimed in claim 1, wherein
the negative electrode comprises a current collector and a negative electrode coating layer located on the current collector and including a lithiophilic metal, a carbon material, or a combination thereof, and
a lithium metal layer formed by charging between the above-described collector and the negative electrode coating layer is included.

14. The all-solid-state rechargeable battery as claimed in claim 1, wherein
the positive electrode comprises a current collector and a positive electrode active material layer located on the current collector and including a positive electrode active material, and
the positive electrode active material comprises lithium cobalt oxide, lithium nickel oxide, lithium nickel cobalt oxide, lithium nickel cobalt aluminum oxide, lithium nickel cobalt manganese oxide, lithium nickel manganese oxide, lithium manganese oxide, lithium iron phosphate, or a combination thereof.
